(19) United States
(12) Patent Application Publication
(10) Pub. No.: US 2012/0249407 A1
(43) Pub. Date: Oct. 4, 2012

(54) Image Display Apparatus and Computer Apparatus Employing Same

(75) Inventor: Atsushi Hatakeyama, Osaka (JP)

(73) Assignee: PANASONIC CORPORATION, Osaka (JP)

(21) Appl. No.: 13/434,853

(22) Filed: Mar. 30, 2012

(30) Foreign Application Priority Data
Mar. 31, 2011 (JP) 2011-079812

(51) Int. Cl. G09G 3/36

(52) U.S. Cl. 345/102

(57) ABSTRACT

An image display apparatus comprises: a liquid crystal panel; and a back light device on the rear face of the liquid crystal panel. The back light device includes: a light guide plate; a reflective sheet; a first and second light sources; and a prism sheet, and emits, to the right relative to the direction of viewing the liquid crystal panel, light emitted from the first light source and emits, to the left relative to the direction of viewing the liquid crystal panel, light emitted from the second light source. On the liquid crystal panel, a partial image obtained by omitting a part of an entire image and a partial image complementary to this are displayed alternately. The light sources and are controlled such as to be turned on alternately in synchronization with the displaying of the partial images on the liquid crystal panel.

### CROSS REFERENCE TO RELATED APPLICATION

This application claims priority to Japanese Patent Application No. 2011-079812, filed on Mar. 31, 2011, the entire contents of which are incorporated herein by reference.

### BACKGROUND OF THE INVENTION

1. Field of the Invention

The present invention relates to an image display apparatus employed in a notebook-type personal computer or the like.

2. Description of the Background Art

In recent years, electronic devices such as notebook-type personal computers, portable phones, and smart phones employing liquid crystal displays are widely used. This causes increasing demands for security protection and privacy protection. Thus, techniques for preventing peeping by persons other than the user have been proposed.

Japanese Laid-Open Patent Publication No. 2005-6881 discloses a technique for, in a game machine provided with an image display apparatus, preventing neighboring game players from peeping into displayed contents on the image display apparatus. Specifically, the image display apparatus described in Japanese Laid-Open Patent Publication No. 2005-6881 mainly includes, in order from the rear side to the front side, a light emission unit constructed by parallel arrangement of a plurality of light emitting elements, a pair of polarizing filters whose polarization characteristics are different from each other, a Fresnel lens, a fine phase difference plate whose polarization characteristics vary region by region, and a liquid crystal display panel (for example, see FIG. 4 and Paragraphs 0024, 0025, and 0031 in Japanese Laid-Open Patent Publication No. 2005-6881). The Fresnel lens guides light emitted from one of the polarizing filters, toward the game player's right eye and guides light emitted from the other polarizing filter, toward the game player's left eye. In accordance with the combination between the polarization directions of the light beams distributed to the right and the left by the Fresnel lens and the polarization characteristics of the individual regions of the fine phase difference plate, the image to be formed on the liquid crystal display panel is divided into a right-eye image and a left-eye image (see FIG. 12 in Japanese Laid-Open Patent Publication No. 2005-6881).

According to the configuration described in Japanese Laid-Open Patent Publication No. 2005-6881, the game player located in front of the game machine sees both the right-eye image and the left-eye image and, hence, recognizes complete displayed contents. In contrast, a person who peeps from a sideward view of the game machine sees only one of the right-eye image and the left-eye image and, hence, cannot recognize the displayed contents.

Nevertheless, in the configuration described in Japanese Laid-Open Patent Publication No. 2005-6881, the light emission unit serving as a light source needs to be arranged at the focal position of the Fresnel lens. Thus, this configuration is difficult to be employed in a thin-screen electronic device such as a notebook-type personal computer.

### SUMMARY OF THE INVENTION

Thus, an object of the present invention is to provide a thin-screen image display apparatus in which peeping into a display screen from a sideward viewpoint is prevented.

The present invention relates to an image display apparatus capable of alternately displaying on a display screen a first partial image obtained by omitting a part of an entire image, and a second partial image complementary to the first partial image. The image display apparatus according to the present invention comprises: a liquid crystal panel; a back light device that includes a light guide member having a rectangular flat plate shape, a prism sheet stacked on one surface of the light guide member, a first light source arranged along a first side-surface of the light guide member, and a second light source arranged along a second side-surface on a side opposite to the first side-surface, and that emits, to the right relative to the direction of viewing the liquid crystal panel, light emitted from the first light source and emits, to the left, light emitted from the second light source; a liquid crystal panel driver for driving the liquid crystal panel such as to display the first partial image and the second partial image alternately; and a back light driver for turning on the first light source and the second light source alternately in synchronization with the displaying of the first partial image and the second partial image.

According to the present invention, from the sideward of the front observer, either the first partial image or the second partial image alone is recognized visually. Thus, recognition of the displayed contents is difficult and, hence, peeping is prevented. Further, since a back light device in which light sources are arranged in the side-surface parts of the light guide plate is employed, thickness reduction of the apparatus is achieved.

These and other objects, features, aspects, and effects of the present invention will become clearer on the basis of the following detailed description with reference to the accompanying drawings.

### BRIEF DESCRIPTION OF THE DRAWINGS

FIG. 1 is a perspective view showing a notebook-type personal computer employing an image display apparatus according to a first embodiment;

FIG. 2 is a schematic configuration diagram showing an image display apparatus according to a first embodiment;

FIG. 3 is a functional block diagram showing an image display apparatus according to a first embodiment;

FIG. 4 is a diagram used for describing a display image in an image display apparatus according to a first embodiment; and

FIG. 5 is a sectional view of an image display apparatus according to a second embodiment.

### DESCRIPTION OF THE PREFERRED EMBODIMENTS

### First Embodiment

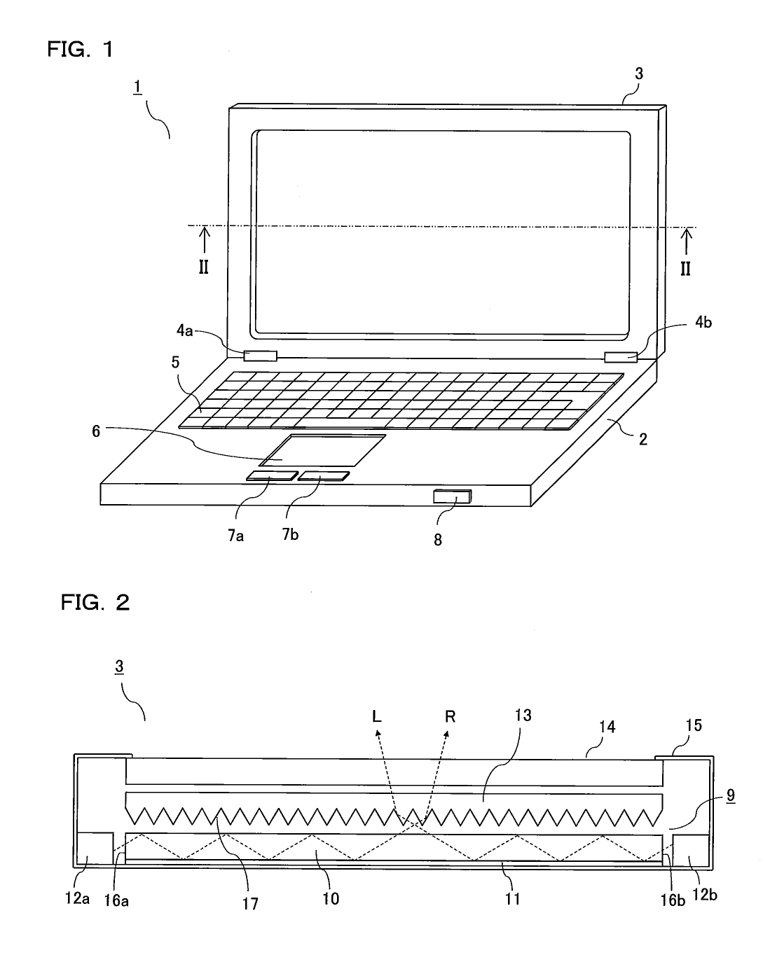

FIG. 1 is a perspective view showing a notebook-type personal computer employing an image display apparatus according to a first embodiment.

A personal computer 1 has: a main body 2 in which a CPU and a storage device are accommodated; and an image display apparatus 3. The image display apparatus 3 is attached to the main body 2 through hinges 4a and 4b in a manner that opening and closing are allowed freely. The main body 2 has a plurality of keys 5, a touchpad 6, buttons 7a and 7b, and a power switch 8. The main body 2 further has: a plurality of connection terminals such as USB terminals; LED lamps; switches; and the like. Illustration of these items is omitted.

FIG. 2 is a schematic configuration diagram showing an image display apparatus according to the first embodiment, which is a sectional view taken along line II-II in FIG. 1.

The image display apparatus 3 has: a liquid crystal panel 14; a back light device 9 arranged on the rear side of the liquid crystal panel 14 and emitting illumination light; and a display control circuit (not shown). The liquid crystal panel 14 and the back light device 9 are accommodated in the inside of a housing 15.

The back light device 9 includes a light guide plate 10, a reflective sheet 11, a pair of light sources 12a and 12b, and a prism sheet 13.

The light guide plate 10 has a rectangular flat plate shape and causes the light emitted from the light sources 12a and 12b to undergo total reflection and diffusion in the inside so as to be homogenized and converted into surface-emitted light. In the light guide plate 10, minute prisms (not shown) are formed for controlling the direction of travel of the emitted light. The minute prisms may be provided only on the front face of the light guide plate 10 or only on the rear face of the light guide plate 10. Alternatively, the minute prisms may be provided on both of the front face and the rear face of the light guide plate 10. When the minute prisms are provided on both of the front face and the rear face of the light guide plate 10, the direction of extension of the front face minute prisms crosses with the direction of extension of the rear face minute prisms.

The reflective sheet 11 is arranged on the rear face of the light guide plate 10 and is stacked on the light guide plate 10. The reflective sheet 11 reflects, toward the front side of the light guide plate 10, the light having been emitted without undergoing total reflection in the rear face of the light guide plate 10.

For example, the light sources 12a and 12b are constructed from LEDs. The one light source 12a is arranged along the side-surface 16a of the light guide plate 10 and emits light into the light guide plate 10 through the side-surface 16a. The other light source 12b is arranged along the side-surface 16b opposite to the side-surface 16a and emits light into the light guide plate 10 through the side-surface 16b. Activation/deactivation of the light sources 12a and 12b is controlled by a back light driver in the display control circuit. The LEDs serving as light sources may be of side-view type or, alternatively, of top-view type. In a case where the directional angle of beam of each light source is large, a reflecting member such as a mirror may be employed in order to limit the range of emitted light.

The prism sheet 13 has a prism surface 17 having a plurality of prisms located therein, where those prisms are formed in a direction perpendicular to the page of FIG. 2. The direction of travel of the light emitted from the light guide plate 10 is changed by, inter alia, refraction in the prism 17 and total reflection in the prism surface 17. In further detail, the light having been emitted from the light source 12a is emitted from the front face of the light guide plate 10 toward the right relative to an observer located in front of the image display apparatus 3. Then, as a result of, inter alia, refraction by the prism surface 17 and total internal reflection at the prism surface 17, the emitted light proceeds rightward, heading toward the back light device 9 and along the front of the back light device 9. Further, the light having been emitted from the light source 12b is emitted from the front face of the light guide plate 10 toward the left relative to the observer located in front of the image display apparatus 3. Then, as a result of, inter alia, refraction by the prism surface 17 and total internal reflection at the prism surface 17, the emitted light proceeds leftward, heading toward the back light device 9 and along the front of the back light device 9. That is, the prism sheet 13 has the function of causing the light having been emitted from the front face of the light guide plate 10 toward an oblique direction to be emitted toward a desired front direction relative to the back light device 9.

The liquid crystal panel 14 has a plurality of pixels arranged in a matrix form. On the basis of driving signals provided from the liquid crystal panel driver of the display control circuit, the transmissivity for the light projected from the rear face is changed in the individual pixels so that an image is displayed. As described later, within the image display apparatus 3 according to the various embodiments described herein, for the purpose of preventing peeping from the right and left, the processing of alternately displaying a pair of mutually complementary partial images generated from one complete image is performed. Thus, in order that the feeling of after-image should be reduced, it is preferable that the liquid crystal panel 14 has a high-speed response.

Here, the back light device 9 may further have a diffusion sheet for causing the entering light to be emitted in a diffused state. The diffusion sheet may be caught between the light guide plate 10 and the prism sheet 13 or, alternatively, may be stacked on the outer side of the prism sheet 13.

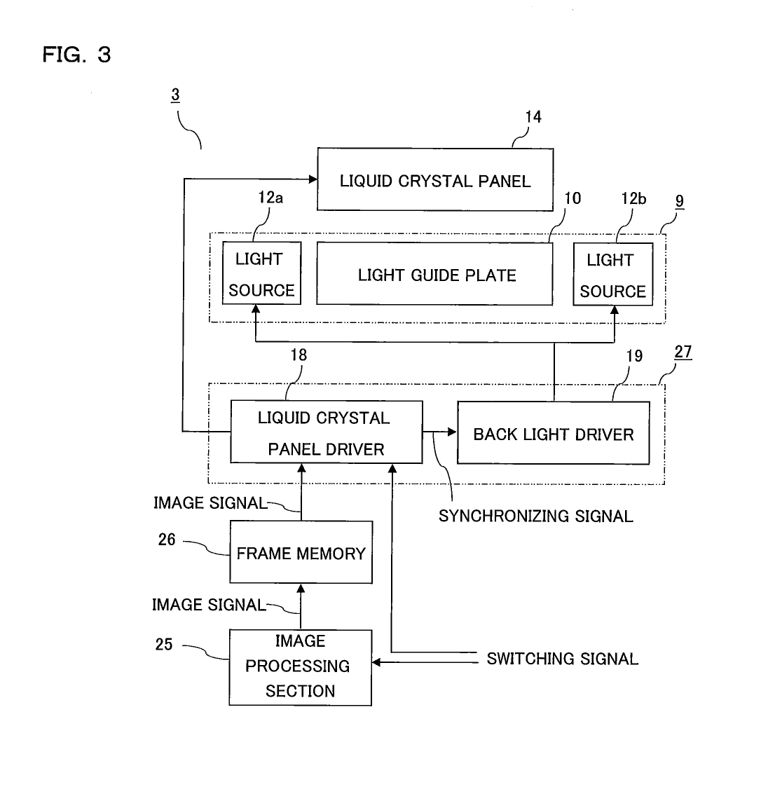

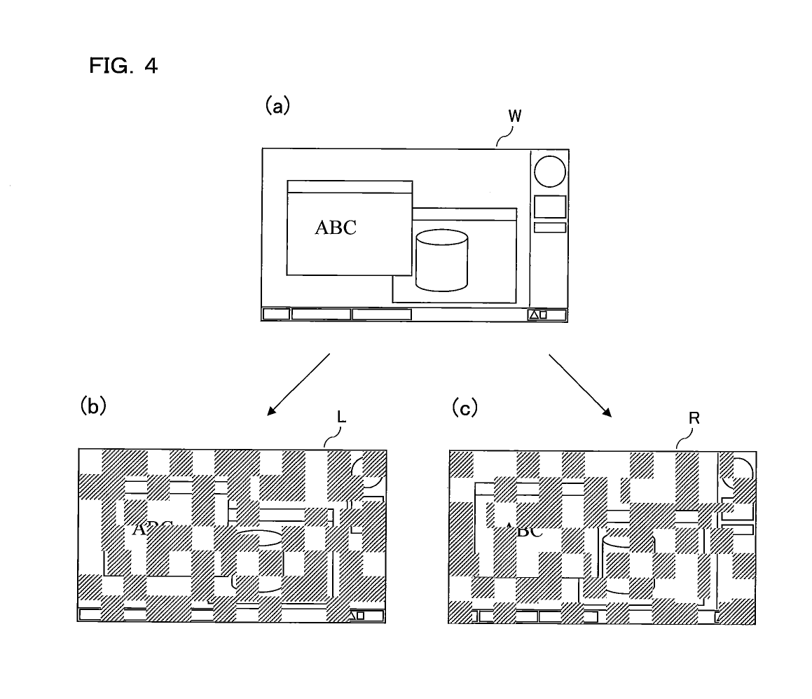

FIG. 3 is a functional block diagram showing an image display apparatus according to the first embodiment. FIG. 4 is a diagram used for describing a display image in an image display apparatus according to the first embodiment.

As shown in FIG. 3, the display control circuit 27 includes a liquid crystal panel driver 18 for driving the liquid crystal panel 14 and a back light driver 19 for driving the light sources 12a and 12b. Further, FIG. 3 shows an image processing section 25 for generating a display image and a frame memory 26 for storing the display image generated by the image processing section 25. In response to a switching signal that instructs switching of the display mode, the image processing section 25 switches and performs the processing of generating an entire image to be displayed on the entirety of the liquid crystal panel 14 and the processing of generating a partial image obtained by omitting a part of the entire image and a partial image complementary to this. Details of these entire image and partial images are described later.

On the basis of the image signals acquired from the frame memory 26, the liquid crystal panel driver 18 generates driving signals used for changing the transmissivity of each pixel of the liquid crystal panel 14, and then outputs the generated driving signals to the liquid crystal panel 14. Further, in response to a switching signal outputted from a dedicated switch or the like provided in the personal computer main body or its housing, the liquid crystal panel driver 18 switches a normal mode that the image display apparatus 3 is driven in an ordinary display scheme and a peeping prevention mode that peeping from the right and left is prevented. The back light driver 19 controls the activation/deactivation and the emission intensity of the light sources 12a and 12b. The control method for the light sources 12a and 12b performed by the back light driver 19 is different from the normal mode and the peeping prevention mode.

First, in the normal mode, the image processing section 25 writes the image signals of an entire image W shown in FIG. 4(a) into the frame memory 26. The liquid crystal panel driver 18 acquires the image signals from the frame memory 26 and then, on the basis of the acquired image signals, displays the entire image W on the entirety of the liquid crystal panel 14. At that time, the back light driver 19 keeps both of the light sources 12a and 12b on. In the case that both of the light sources 12a and 12b are to be turned on, the light emission intensity of each light source may be reduced (for example, to a half).

Next, when the user instructs switching from the normal mode to the peeping prevention mode by using an input device such as a keyboard and a touchpad or, alternatively, by using a dedicated switch or the like in the housing, a signal that instructs switching of the display mode is outputted from the personal computer main body or the like to the display control circuit 27. In the peeping prevention mode, the image processing section 25 writes into the frame memory 26 the image signals of the partial image L or partial image R from the entire image W as shown in FIG. 4(b) or 4(c). The partial image L and the partial image R are generated by omitting a part of the entire image W and complementary to each other. Set up of the omitted parts (shaded parts) in the partial image L and the partial image R may be arbitrary as long as the detailed contents of the entire image are not recognized easily. In the example in FIG. 4, pixel regions in the image are omitted in a mosaic manner. It is preferable that the omitted parts are displayed in black. However, another color may be employed depending on the colors used in the image, the number of displayable colors in the liquid crystal panel, and the like.

Here, the partial image L and the partial image R may be generated by software or, alternatively, by hardware. In the former case, the CPU in the personal computer main body expands onto a memory a program installed on a hard disk, and then executes the program so as to implement the image processing section 25 as shown in FIG. 3. In the latter case, the image processing section 25 as shown in FIG. 3 is implemented by an LSI or the like provided with a circuit for generating the partial image L and the partial image R. In the case that the image processing section 25 is constructed in the form of hardware, the image processing section 25 and the frame memory 26 may be provided in the personal computer main body or, alternatively, in the image display apparatus 3.

The liquid crystal panel driver 18 alternately displays the partial image L and the partial image R on the liquid crystal panel 14. At that time, in order that flicker in the image and the perception of after-image should be reduced, it is preferable that the drive frequency for the liquid crystal panel 14 be higher than that in the normal mode. For example, in the peeping prevention mode, the liquid crystal panel 14 may be driven at a frequency equal to an even-number multiple of the drive frequency in the normal mode. Specifically, the liquid crystal panel 14 may be driven at a frequency of 120 Hz or 240 Hz which is twice or four times of the normal-mode drive frequency of 60 Hz.

In synchronization with the drive of the liquid crystal panel performed by the liquid crystal panel driver 18, the back light driver 19 turns on the light sources 12a and 12b alternately. Specifically, during the period that the liquid crystal panel driver 18 displays the partial image L on the liquid crystal panel 14, the back light driver 19 turns on the light source 12b alone. Then, in synchronization with switching from the partial image L to the partial image R, the back light driver 19 turns off the light source 12b and turns on the other light source 12a. Further, during the period that the liquid crystal panel driver 18 displays the partial image R on the liquid crystal panel 14, the back light driver 19 turns on the light source 12a alone. The synchronization between the back light driver 19 and the liquid crystal panel driver 18 is performed based on a synchronizing signal outputted from the liquid crystal panel driver.

Here, in this example, the light source 12b is turned on during the period of display of the partial image L and the light source 12a is turned on during the period of display of the partial image R. However, this combination may be reversed. Further, the synchronization between the liquid crystal panel driver 18 and the back light driver 19 may be performed based on a synchronizing signal that is outputted from either one of the drivers to the other or, alternatively, based on a common synchronizing signal generated by the display control circuit 27. Such a synchronizing signal may be provided from the outside of the display control circuit 27.

As described above, the light emitted from the light source 12a is guided to the right of the observer located in front of the liquid crystal panel 14 and the light emitted from the light source 12b is guided to the left of the observer. As such, the light emitted from the light source 12a and the light emitted from the light source 12b have mutually different directivities. Thus, while the display regions of the partial image L and the partial image R overlap with each other partly in front of the liquid crystal panel 14, in the outside, the display region of the partial image L alone or the display region of the partial image R alone is generated.

Thus, the observer located in front of the liquid crystal panel 14 sees both of the partial images L and R whose display is switched alternately and, hence, recognizes as if the entire image W were displayed on the liquid crystal panel 14. In contrast, when the liquid crystal panel 14 is viewed from a position on the sideward relative to the front of the liquid crystal panel 14, only one of the partial images L and R is seen, it is difficult to immediately recognize the contents of the original entire image W.

As described above, in the present embodiment, the back light device 9 is constructed from the light guide plate 10 and from the pair of light sources 12a and 12b arranged along the side-surfaces 16a and 16b. This permits thickness reduction in the image display apparatus 3. Further, in the sideward view relative to the front observer, light emission ranges where only the partial image L or R are reduced. This degrades the visibility of the display screen when viewed from the sideward of the observer, so that resistance against peeping is improved.

### Second Embodiment

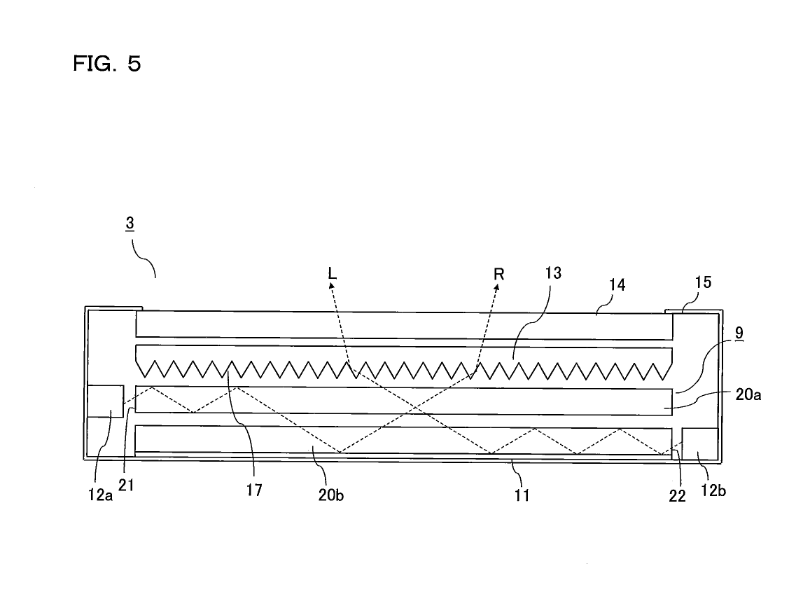

FIG. 5 is a sectional view of an image display apparatus according to a second embodiment, which corresponds to FIG. 2.

The image display apparatus 3 shown in FIG. 5 is remarkably different from the first embodiment in that the back light device 9 is constructed using a pair of light guide plates 20a and 20b each having a rectangular flat plate shape. The light guide plates 20a and 20b are arranged in this order on the rear side of the prism sheet 13.

The one light source 12a is arranged along the side-surface 21 of the light guide plate 20a and emits light into the light guide plate 20a through the side-surface 21. The light emitted from the light source 12a undergoes total reflection repeatedly in the inside of the light guide plate 20a so as to be converted into surface-emitted light. A part of the light having entered the light guide plate 20a exits from the rear face of the light guide plate 20a, then passes through the light guide plate 20b, then is reflected by the reflective sheet 11, and then passes through the light guide plate 20a again so as to reach the prism sheet 13.

The other light source 12b is arranged along a side-surface 22 which is one side-surface of the light guide plate 20b and is located on the side opposite to the side-surface 21 of the light guide plate 20a. Then, the light source 12b emits light into the light guide plate 20b through the side-surface 22. A reflective sheet 11 is arranged on the rear face of the light guide plate 20b and is stacked on the light guide plate 20b. The light having entered the light guide plate 20b undergoes total reflection repeatedly in the inside of the light guide plate 20b so as to be converted into surface-emitted light. The light having exited from the light guide plate 20b passes through the front light guide plate 20a so as to reach the prism sheet 13.

In the light guide plates 20a and 20b, minute prisms are formed that control the light beams to be emitted at a desired exiting angle when the two light guide plates 20a and 20b are used in combination. As described in the first embodiment, the minute prisms are formed in one or both of the front face and the rear face of the light guide plate.

In the configuration according to the present embodiment, the two light guide plates 20a and 20b are necessary. However, the minute prisms formed in the light guide plates 20a and 20b are allowed to be optimized independently in accordance with the individual light sources 12a and 12b. This permits precise control of the exiting angles.

Here, also in the back light device 9 according to the present embodiment, a diffusion sheet may further be provided that causes the entering light to be emitted in a diffused state. The diffusion sheet may be caught between the light guide plate 20a and the prism sheet 13 or, alternatively, may be stacked on the outer side of the prism sheet 13.

The image display apparatus according to the present invention may be employed in an electronic device such as a portable telephone, a smart phone, and a tablet computer provided with a display section.

Details of the present invention have been described above. However, the above-mentioned description is completely illustrative from every point of view, and does not limit the scope of the present invention. Obviously, various improvements and modifications can be performed without departing from the scope of the present invention.

What is claimed is:

1. An image display apparatus capable of alternately displaying on a display screen a first partial image obtained by omitting a part of an entire image and a second partial image complementary to the first partial image, the image display apparatus comprising:
a liquid crystal panel;
a back light device that includes a light guide member having a rectangular flat plate shape, a prism sheet stacked on one surface of the light guide member, a first light source arranged along a first side-surface of the light guide member, a second light source arranged along a second side-surface on a side opposite to the first side-surface, that emits, to the right relative to a direction of viewing the liquid crystal panel, light emitted from the first light source and emits, to the left, light emitted from the second light source;
a liquid crystal panel driver for driving the liquid crystal panel to display the first partial image and the second partial image alternately; and
a back light driver for turning on the first light source and the second light source alternately in synchronization with the displaying of the first partial image and the second partial image.

2. The image display apparatus as claimed in claim 1, wherein
the liquid crystal panel driver is capable of being switched between a first operation of, in response to a switching signal inputted from the outside, thereby driving the liquid crystal panel to display the entire image on the entirety of the liquid crystal panel and a second operation of displaying on the liquid crystal panel the first partial image and the second partial image alternately, and wherein
the drive frequency for the liquid crystal panel in the second operation is an even-number multiple of the drive frequency for the liquid crystal panel in the first operation.

3. The image display apparatus as claimed in claim 1, further comprising an image processing section for generating the first partial image and the second partial image from the entire image.

4. A computer apparatus comprising: an image display apparatus as claimed in claim 1; and a main body for outputting a display image signal to the image display apparatus, wherein
the main body includes an image processing section for generating the first partial image and the second partial image from the entire image.
